(19) United States
(12) Patent Application Publication
(10) Pub. No.: US 2026/0299172 A1
(43) Pub. Date: Oct. 1, 2026

(54) PLASTIC OPTICAL LENS

(71) Applicant: Genius Electronic Optical (Xiamen) Co., Ltd., Xiamen (CN)

(72) Inventors: HUA FENG GONG, Xiamen (CN); CHU ZI WEI, Xiamen (CN)

(73) Assignee: Genius Electronic Optical (Xiamen) Co., Ltd., Xiamen (CN)

(21) Appl. No.: 19/245,697

(22) Filed: Jun. 23, 2025

(30) Foreign Application Priority Data
Mar. 31, 2025 (CN) 2025103904523

(51) Int. Cl. G02B 3/00; G02B 1/04

(52) U.S. Cl. CPC G02B 3/00; G02B 1/041; G02B 2003/0093

(57) ABSTRACT

The present invention provides a plastic optical lens, which comprises an optical portion being passed by an optical axis and a mounting portion surrounding the optical portion. The mounting portion comprises a first surface facing a first side, a circular barrel mounting surface, a second surface facing a second side and connecting with the circular barrel mounting surface and a gate cutting surface connecting with the circular barrel mounting surface. The plastic optical lens may optionally comprise a protruding rim in the mounting portion or at least one multi-chamfering corner. Through controlling position and structure of the mounting portion or the multi-chamfering corner, it is beneficial to reduce demoulding resistance at different positions of the plastic optical lens to promote molding precision, so as to raise molding yield and mounting quality as well.

### CROSS-REFERENCE TO RELATED APPLICATIONS

This application claims priority from P.R.C. patent application No. 2025103904523 titled “Plastic Optical Lens,” filed Mar. 31, 2025, with the State Intellectual Property Office of the People's Republic of China (SIPO), the contents of which are hereby incorporated by reference in their entirety for all purposes.

### TECHNICAL FIELD

The present disclosure relates to a plastic optical lens, and particularly, to a plastic optical lens which is adapted to an optical imaging lens or an optical lens assembly.

### BACKGROUND

As the specifications of mobile electronic devices are constantly changing, the key component, optical imaging lens or optical lens assembly, must be continuously upgraded to meet the needs of consumers for various applications. Optical lenses are essential components in optical imaging lenses or optical lens assemblies. The quality of the optical lens itself will directly affect the optical quality of the optical imaging lens or optical lens assembly, so how to make a stable and good quality optical lens is a project that must be continuously studied for the optical imaging lens or optical lens assembly.

Most of the optical imaging lenses or optical lens assemblies of existing mobile electronic devices are made of plastic material by injection molding technology in order to make them smaller in size. The principle of injection molding is to take advantage of the thermoplasticity of plastic raw materials. At first, a plastic raw material is melted into a molten fluid. Then, the molten fluid is injected into a cavity of a mold under high pressure, and then it is taken out after cooling. The cavity of the mode may be shaped in a variety of special shapes, so as to obtain the resultant plastic product, such as a plastic optical lens of the optical imaging lenses or optical lens assemblies, made by injection molding technology, in a variety of special shapes for various special usages or properties. Different parameters such as melt temperature, injection speed, holding pressure and cooling time may generate excessive residual stress at different locations of the plastic optical lens during injection molding, which will make the plastic optical lens susceptible to stress release and friction with the mold during demolding, resulting in demolding resistance that causes problems such as appearance variations, poor flatness, and unstable dimensional accuracy.

Controlling the stress release during demolding of plastic optical lenses is therefore a challenge to be solved.

### SUMMARY

The present invention provides a plastic optical lens that can be applied to an optical imaging lens or an optical lens assembly. The optical imaging lens or optical lens assembly can capture images and/or record video, and may be used in mobile electronic products such as cell phones, cameras, tablet computers, Personal Digital Assistants (PDAs), and the like, without limitation. The plastic optical lens according to the present invention comprises an optical portion passed by a central axis and a mounting portion enclosing at least a partial of the optical portion. The mounting portion comprises a first surface facing a first side, a circular barrel mounting surface, a second surface facing a second side and connecting with the circular barrel mounting surface, and a gate cutting surface connected to the circular barrel mounting surface. The plastic optical lens optionally forms a protruding rim at the mounting portion and/or at least a multi-chamfering corner at the second surface. By controlling the position and structure of the protruding rim and/or the multi-chamfering corner, it is beneficial to reduce resistance at different positions of the plastic optical lens during demolding, improve molding accuracy, and thus enhance molding yield while taking into account assembly quality.

In the specification, parameters used herein may include, without limitation:

| Parameters | Definition |
|---|---|
| CTmax | A maximum thickness of the plastic optical lens along the central axis. |
| Wa | A maximum thickness of the mounting portion of the plastic optical lens, parallel |
| | to the central axis. |
| Wc | A maximum width of the protruding rim in the mounting portion of the plastic |
| | optical lens, parallel to the central axis. |
| Wcb | A maximum width of the circular barrel mounting surface in the mounting portion |
| | of the plastic optical lens, parallel to the central axis. |
| Wcp | A maximum width of the circular barrel mounting surface in the mounting portion |
| | of the plastic optical lens along a radial direction, taking the central axis as the |
| | center. |
| Wgs | A maximum width of the multi-chamfering corner in the mounting portion of the |
| | plastic optical lens, parallel to the central axis. |
| Ra max | A maximum radius of the mounting portion of the plastic optical lens. |
| Rc max | A maximum radius of the circular barrel mounting surface of the plastic optical |
| | lens. |
| Ro min | A minimum radius of the optical portion of the plastic optical lens. |
| Tplup | A maximum distance between the circular barrel mounting surface of the plastic |
| | optical lens to the first surface of the plastic optical lens. |

According to an embodiment of the present invention, a plastic optical lens is provided, in which a protruding rim may be formed within a first radial range, taking a central axis thereof as the center, and connecting with the first surface and a circular barrel mounting surface. The first radial range may at least comprise a second radial range opposite to a gate cutting surface. The protruding rim may comprise a ring surface and a conic surface. The conic surface may connect with the ring surface and the circular barrel mounting surface. The ring surface may connect with the first surface forming a maximum radius of lens at the place where the conic surface connects with the ring surface. The plastic optical lens may satisfy 2.600≤Wcb/Wc≤11.700 and 0.055≤θc/360 degrees≤0.920, in which θc represents a sum of at least one central angle, formed by the first radial range and the central axis.

According to another embodiment of the present invention, the protruding rim may be formed within a first radial range, taking the central axis as the center, and may connect with the first surface and the circular barrel mounting surface. The first radial range may comprise at least a second radial range opposite to the gate cutting surface. The protruding rim may comprise a ring surface and a conic surface, the conic surface connecting with the ring surface and the circular barrel mounting surface, and the ring surface connecting with the first surface forming a maximum radius of lens the conic surface at the place where the conic surface connects with the ring surface. The plastic optical lens may satisfy 0.650≤Wcb/Tplup≤6.400. The plastic optical lens may further satisfy 0.055≤θc/360 degrees≤0.920, in which θc represents a sum of at least one central angle formed by the first radial range and the central axis.

According to yet another embodiment of the present invention, the circular barrel mounting surface may connect with the first surface and may be parallel to the central axis. The second surface may comprise at least one multi-chamfering corner in vicinity of the gate cutting surface, the at least one multi-chamfering corner connecting with the circular barrel mounting surface. The at least one multi-chamfering corner may comprise a first surface and a second surface. The first surface, compared with the second surface, may be relatively closer to the circular barrel mounting surface. Two included angles, formed by a tangent line of either the first surface or the second surface and the central axis, may be within 10~45 degrees, and among the two included angles, the one, formed by the tangent line of the first surface and the central axis, may be greater. The plastic optical lens may satisfy 0.055≤θgs/360 degrees≤0.920 and 0.300≤Wcb/Wgs≤2.250, in which θgs represents a sum of at least one central angle formed by the at least one multi-chamfering corner and the central axis respectively.

### BRIEF DESCRIPTION OF THE DRAWINGS

Exemplary embodiments will be more readily understood from the following detailed description when read in conjunction with the appended drawing, in which:

FIG. 1 shows a cross-sectional view of a plastic optical lens according to a first embodiment of the present invention;

FIG. 2 shows an enlarged view of the partial plastic optical lens according to the first embodiment of the present invention;

FIG. 3 shows a perspective view of a lens surface of the plastic optical lens according to the first embodiment of the present invention;

FIG. 4 shows a perspective view of a lens surface of the plastic optical lens according to a second embodiment of the present invention;

FIG. 5 shows a perspective view of a lens surface of the plastic optical lens according to a third embodiment of the present invention;

FIG. 6 shows a cross-sectional view of the plastic optical lens according to the third embodiment of the present invention;

FIG. 7 shows a perspective view of a lens surface of the plastic optical lens according to a fourth embodiment of the present invention;

FIG. 8 shows a perspective view of a lens surface of the plastic optical lens according to a fifth embodiment of the present invention;

FIG. 9 shows a perspective view of a lens surface of the plastic optical lens according to a sixth embodiment of the present invention;

FIG. 10 shows a cross-sectional view of a plastic optical lens according to a seventh embodiment of the present invention;

FIG. 11 shows a perspective view of a lens surface of the plastic optical lens according to the seventh embodiment of the present invention;

FIG. 12 shows a cross-sectional view of a plastic optical lens according to an eighth embodiment of the present invention;

FIG. 13 shows a perspective view of a lens surface of the plastic optical lens according to the eighth embodiment of the present invention;

FIG. 14 shows a cross-sectional view of a plastic optical lens according to a ninth embodiment of the present invention;

FIG. 15 shows a perspective view of a lens surface of the plastic optical lens according to the ninth embodiment of the present invention;

FIG. 16 shows a cross-sectional view of a plastic optical lens according to a tenth embodiment of the present invention;

FIG. 17 shows a perspective view of a lens surface of the plastic optical lens according to the tenth embodiment of the present invention;

FIG. 18 shows a cross-sectional view of a plastic optical lens according to an eleventh embodiment of the present invention;

FIG. 19 shows a perspective view of a lens surface of the plastic optical lens according to the eleventh embodiment of the present invention.

### DETAILED DESCRIPTION

For a more complete understanding of the present disclosure and its advantages, reference is now made to the following description taken in conjunction with the accompanying drawings, in which like reference numbers indicate like features. Persons of ordinary skill in the art having the benefit of the present disclosure will understand other variations for implementing embodiments within the scope of the present disclosure, including those specific examples described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

The terms “optical portion,” “mounting portion,” “first side,” and “second side,” as used herein and in the scope of the patent application, shall be construed based on the definitions set forth herein.

Any of the plastic optical lenses in this manual can be applied to an optical imaging lens or optical lens assembly in a mobile electronic product. Mobile electronic products such as cell phones, cameras, tablet PCs, Personal Digital Assistants (PDAs), etc. are not limited. The optical imaging lens or optical lens assembly may provide the function of capturing images and recording during operation, and its action during operation may include receiving imaging that are incident on the plastic optical lens over a set of angles ranging from parallel to an optical axis to a half field of view (HFOV) angle with respect to the optical axis, and the imaging rays pass through the optical lens assembly and are imaged on an imaging plane.

A plastic optical lens is generally a relatively flat structure formed by two opposing lens surfaces at the front and back and a contoured surface of the lens edge between the two lens surfaces, which are functionally differentiated into an optical portion that is passed by a central axis and a mounting portion that encloses the optical portion. The overall orientation of the two lens surfaces represents a first side and a second side respectively, and may correspond to the direction of incident imaging rays and the direction of imaging formation in the applicable optical imaging lens or optical lens assembly. Preferably, the first side may be predetermined as the direction facing the incident imaging rays, hereinafter referred to as the “object side A1”, and the second side may be predetermined as the direction facing the image formed by the imaging rays, hereinafter referred to as the “image side A2.” At this time, the first side and the second side are two directions opposite to each other.

The optical portion of a plastic optical lens is defined as a predetermined specific range of imaging rays passing through the lens surface in an applicable optical imaging lens or optical lens assembly, and preferably, the optical portion is a partial of a cylinder or cone, defined by a central axis and at least one radius. When the plastic optical lens assembly is assembled in an applicable optical imaging lens, the central axis is ideally aligned to the optical axis of the optical imaging lens to ensure image quality. The mounting portion of a plastic optical lens is defined as all of the portion of the optical portion that encloses the optical portion outside the optical portion to an outer contour surface of a lens edge of the plastic optical lens.

The mounting portion may comprise a first surface facing a first side, a circular barrel mounting surface, a second surface facing a second side and connecting with the circular barrel mounting surface, and a gate cutting surface connecting with the circular barrel mounting surface. The circular barrel mounting surface corresponds to the portion of the outer contour surface of the lens edge that abuts an inner contour of a lens barrel when the plastic optical lens is mounted in an applicable optical imaging lens or optical lens assembly, typically a circular surface parallel to the central axis. Since the plastic optical lens herein is produced by injection molding technology, the process involves injecting hot molten plastic material into a cavity of a mold through a gate, cooling and forming the plastic material, releasing the plastic optical lens from the mold after opening the mode and pushed from the mold, and then separating the plastic optical lens from excessive plastic material by a cutting step, the plastic optical lens comprises the gate cutting surface formed by the cutting step. Due to the nature of the cutting step, the gate cutting surface is usually a flat surface. The plastic optical lens of the present invention optionally forms a protruding rim at the mounting portion and/or at least a multi-chamfering corner at the second surface. By controlling the position and structure of the protruding rim and/or the multi-chamfering corner, it will be advantageous to reduce the resistance at different positions of the plastic optical lens during demolding, improve the molding precision, and further enhance the molding yield while taking into account the assembly quality. Preferably, when controlling the position and structure of the protruding rim and/or multi-chamfering corner relative to the gate cutting surface, even better results can be achieved. This is due to the fact that the demolding process of the plastic optical lens produces different levels of deformation on the side of the gate and on the opposite side of the gate.

According to an embodiment of the present invention, a plastic optical lens is provided, in which a protruding rim may be formed within a first radial range, taking a central axis thereof as the center, and connecting with the first surface and a circular barrel mounting surface. The first radial range may at least comprise a second radial range opposite to a gate cutting surface. The protruding rim may comprise a ring surface and a conic surface. The conic surface may connect with the ring surface and the circular barrel mounting surface. The ring surface may connect with the first surface forming a maximum radius of lens at the place where the conic surface connects with the ring surface. The plastic optical lens may satisfy 2.600≤Wcb/Wc≤11.700 and 0.055≤θc/360 degrees≤0.920, in which θc represents a sum of at least one central angle, formed by the first radial range and the central axis.

According to another embodiment of the present invention, the protruding rim may be formed within a first radial range, taking the central axis as the center, and may connect with the first surface and the circular barrel mounting surface. The first radial range may comprise at least a second radial range opposite to the gate cutting surface. The protruding rim may comprise a ring surface and a conic surface, the conic surface connecting with the ring surface and the circular barrel mounting surface, and the ring surface connecting with the first surface forming a maximum radius of lens the conic surface at the place where the conic surface connects with the ring surface. The plastic optical lens may satisfy 0.650≤Wcb/Tplup≤6.400. The plastic optical lens may further satisfy 0.055≤θc/360 degrees≤0.920, in which θc represents a sum of at least one central angle formed by the first radial range and the central axis.

According to yet another embodiment of the present invention, the circular barrel mounting surface may connect with the first surface and may be parallel to the central axis. The second surface may comprise at least one multi-chamfering corner in vicinity of the gate cutting surface, the at least one multi-chamfering corner connecting with the circular barrel mounting surface. The at least one multi-chamfering corner may comprise a first surface and a second surface. The first surface, compared with the second surface, may be relatively closer to the circular barrel mounting surface. Two included angles, formed by a tangent line of either the first surface or the second surface and the central axis, may be within 10~45 degrees, and among the two included angles, the one, formed by the tangent line of the first surface and the central axis, may be greater. The plastic optical lens may satisfy 0.055≤θgs/360 degrees≤0.920 and 0.300≤Wcb/Wgs≤2.250, in which θgs represents a sum of at least one central angle formed by the at least one multi-chamfering corner and the central axis respectively.

The present invention is not limited to embodiments as follows. All of the numerical ranges including the maximum and minimum values and the values therebetween which are obtained from the combining proportion relation of the optical parameters disclosed in each embodiment of the present disclosure are implementable.

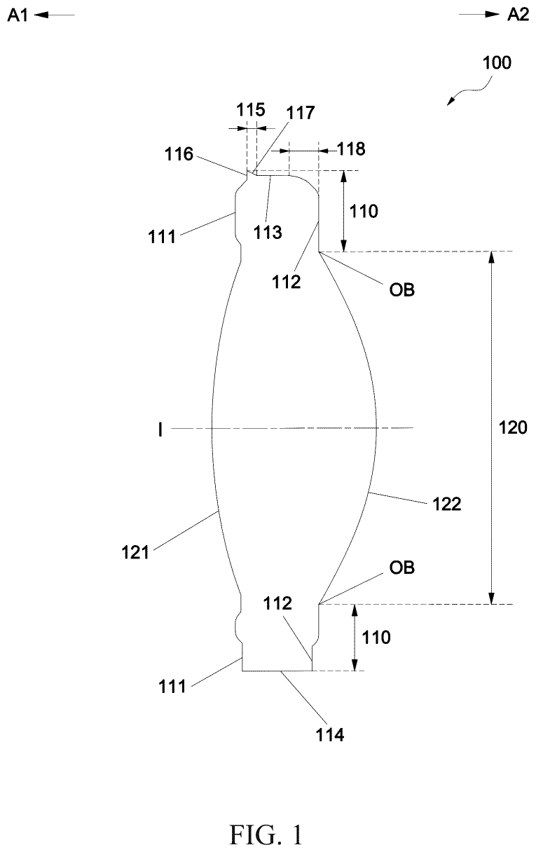

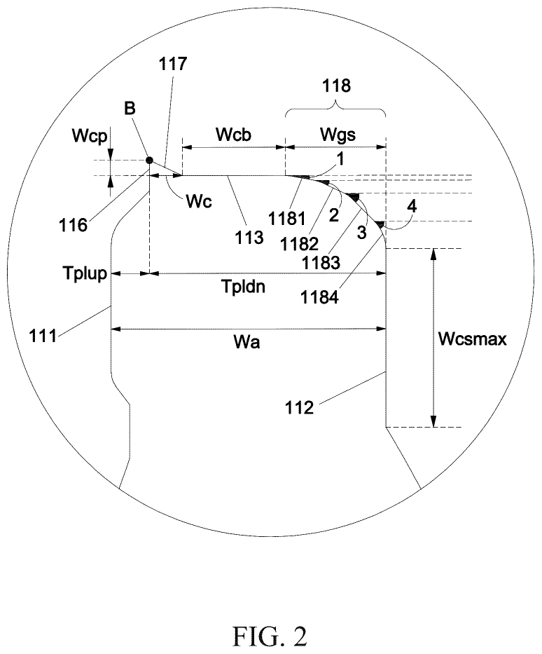

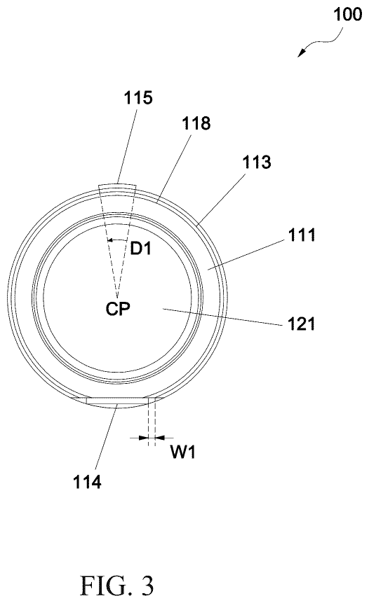

Referring to FIGS. 1~3, in which FIG. 1 shows a cross-sectional view of a plastic optical lens according to a first embodiment of the present invention, FIG. 2 shows an enlarged view of the partial plastic optical lens according to the first embodiment of the present invention, and FIG. 3 shows a perspective view of a lens surface of the plastic optical lens according to the first embodiment of the present invention.

The plastic optical lens 100 comprises an optical portion 120 passed by a central axis I and a mounting portion 110 enclosing the optical portion 120. FIGS. 1 and 2 show a cross-section of the lens, cut by a section line along the direction of the central axis I. The optical boundary OB represents the intersection of the optical portion 120 and the mounting portion 110 on the lens surface, and is physically defined as a point at which the radially outermost marginal ray passing through the surface of the lens element intersects the lens surface. FIG. 3 shows the lens surface facing an object side A1 with the central axis I as the planar direction of the drawing, and a central point CP is used to represent the ideal position where the central axis I passes through the surface of the lens. The mounting port 110 contains a first surface 111, a second surface 112, a circular barrel mounting surface 113, a gate cutting surface 114, and a protruding rim 115. The first surface 111 and the second surface 112 are two opposing lens surfaces of the plastic optical lens 100, and in the present embodiment the first surface 111 is exemplified as a lens surface facing the object side A1, and the second surface 112 is exemplified as a lens surface facing the an image side A2. The second surface 112 is an image side A2. However, in other embodiments, other orientations may be arranged to represent the first side and the second side, for example: the first surface is the lens surface facing the image side A2, the second surface is the lens surface facing the object side A1, and is not limited thereto.

In the present embodiment, the second surface 112 comprises at least one multi-chamfering corner 118 connecting with the circular barrel mounting surface 113, one multi-chamfering corner 118 being used here as an example. The multi-chamfering corner 118 is designed for conditions where stress accumulates in the vicinity of the gate cutting surface 114, and is therefore preferably located in the vicinity of the gate cutting surface 114. More preferably, the location of the multi-chamfering corner 118 may cover at least the gate cutting surface 114 and/or nearby area of the gate cutting surface 114. For example, the multi-chamfering corner 118 may be located adjacent to the gate cutting surface 114 with a distance W1 (shown in FIG. 3) therebetween, and a minimum value of the distance W1 may be close to zero.

Each multi-chamfering corner 118 forms a central angle with the central axis I. A sum of the central angles formed by all the multi-chamfering corners 118, with the central axis I respectively, is θgs. There is no limitation on the sum of the central angles θgs, but it is preferable that it is not greater than 180 degrees, e.g., 60 degrees, but it is not limited to this. In the present embodiment, the sum of the central angle θgs is 309 degrees for example. The plastic optical lens 100 may satisfy 0.055≤θgs/360 degrees≤0.920. At this time, the molding precision can be improved by reducing the local demolding resistance, and the molding yield can be promoted. Preferably, the plastic optical lens 100 may satisfy 0.055≤θgs/360 degrees≤0.500, so as to set the multi-chamfering corner 118 for the stress concentration area and increase the mounting portion, and at the same time, we can improve the stability and the assembly yield of the plastic optical lens 100 molding.

In detail, as can be seen in FIG. 2, the multi-chamfering corner 118 comprises a plurality of surfaces, which are herein exemplified as first, second, third, and fourth surfaces 1181~1184, arranged in order of proximity to the circular barrel mounting surface 113. For the first, second, third, and fourth surfaces 1181~1184, the closer to the circular barrel mounting surface 113 they are, the smaller the angle (i.e., included angle 1, included angle 2, included angle 3, and included angle 4 shown in FIG. 2) between a tangent line of them and the central axis I is. In other words, the farther away from the circular barrel mounting surface 113 they are, the larger the angle between their tangent lines and the central axis I is. For example, if the first surface 1181 which is closer to the circular barrel mounting surface 113 is compared to the second surface 1182 which is farther away from the circular barrel mounting surface 113, the included angle 1 between the tangent line of the first surface 1181 and the central axis I is smaller than the included angle 4 of between the tangent line of the second surface 1182 and the central axis I. Preferably, each of the included angles 1~4 between the tangent lines of one of the first, second, third and fourth surfaces 1181~1184 of the multi-chamfering corner 118 and the central axis I is limited to 10 to 50 degrees to reduce the stresses around the gate cutting surface 114 and the deeper parts of the mold that accumulate in the mold during demolding, so as to improve the molding accuracy and increase the molding yield.

The outer contour surface of the lens edge between the first surface 111 and the second surface 112 is herein subdivided into the gate cutting surface 114, the circular barrel mounting surface 113, and the protruding rim 115. In the present embodiment, the positions of the gate cutting surface 114 and the protruding rim 115 are arranged exemplarily and are not limited thereto. For example, in the present embodiment, the gate cutting surface 114 is set at the lower edge shown in FIGS. 1 and 2, the protruding rim 115, connected between the first surface 111 and the circular barrel mounting surface 113, extends in a first radial range D1 (shown in FIG. 3) with the central axis I as the center, and the first radial range D1 comprises a second radial range located in the direction opposite to the gate cutting surface 114. Here, the first radial range D1 is identical to the second radial range, both of which correspond to an arc length of a 19-degree central angle, taking the central axis I as the center, i.e., the first radial range D1 overlaps with the second radial range. However, in some other embodiments, the gate cutting surface or the protruding rim may also be positioned at other locations. For example, the protruding rim may be closer to the second surface or may be connected between the second surface and the circular barrel mounting surface, the first radial range may correspond to the arc length of another central angle including the second radial range with the central axis In addition, the position and size of the second radial range can also be varied, not limited to the arc length of the 19-degree center angle with the central axis I as the center in the direction opposite to the gate cutting surface 114 in the present embodiment, but adjusted to an arc length of another central angle which is more than 1 degree, with the central axis I as the center, in the direction opposite to the gate cutting surface 114. For example, the first radial range D1, within which the protruding rim 115 is extended, can be adjusted to another arc length of a circular angle of 301 degrees with the central axis I as the center in the direction opposite to the gate cutting surface 114.

The position of the protruding rim 115 may vary depending on the design of the mold itself, such as to correspond to a place where stress concentrates during demolding, so as to reduce the resistance of the plastic optical lens 100 during demolding. For example, the protruding rim 115, connecting between the first surface 111 the circular barrel mounting surface 113 and extending within the first radial range D1, as designed in the present embodiment, may assist the plastic optical lens 100 in reducing the accumulated stress in the area where the stress concentrates, i.e. the area between the first surface 111 and the circular barrel mounting surface 113 in the direction opposite to the gate cutting surface 114, when the plastic optical lens 100 is removed from the mold during the manufacturing process. As such, the molding precision, as well as the molding yield, may be promoted. The design of the first radial range D1 is as follows: through the central angle formed by the first radial range D1 and the central axis I, the first radial range D1 is controlled, and through satisfying 0.055≤θc/360 degrees≤0.920, and the aforementioned advantages can be shown, in which θc is the sum of the central angle formed by the first radial range D1 and the central axis I. Preferably, when satisfying 0.300≤θc/360 degrees≤0.920, the difficulty of lens processing may be further reduced, and the problem of deformation when demolding may be alleviated, which is favorable to the stability of molding.

In detail, the protruding rim 115 contains a ring surface 116 and a conic surface 117, and the conic surface 117 is connected with the ring surface 116 and the circular barrel mounting surface 113, and the ring surface 116 is connected with the first surface 111, so as to form a maximum radius of lens at a point where the conic surface 117 is connected with the ring surface 116, i.e., point B in FIG. 2. Compared to a radial direction with the direction of the central axis I as the center, the ring surface 116 is preferably a parallel plane, and the conic surface 117 is preferably formed at a tilted angle, so that the conic surface 117 can be used to reduce the resistance during demolding and improve the molding yield.

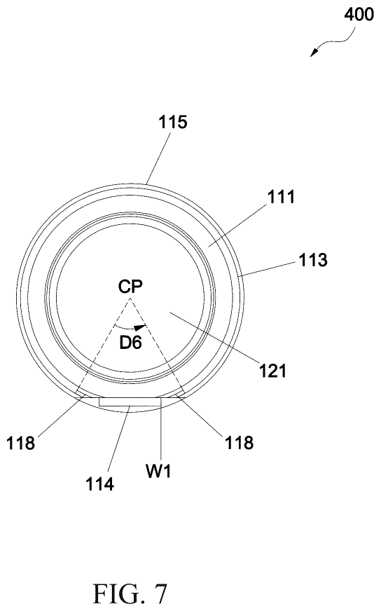

The plastic optical lens 100 of the present embodiment may also satisfy at least one of the following inequalities:

$$2.600 ≦ Wcb / Wc ≦ 11.7 ; \qquad Inequality ( 1 )$$

$$0.65 0 ≦ Wcb / Tplup ≦ 6.4 ; \qquad Inequality ( 2 )$$

$$1.3 0 ≦ ( Wc + Wcb ) / Wcp ≦ 11 \text{.000} ; \qquad Inequality ( 3 )$$

$$0.25 0 ≦ Wc / Wcp ≦ 2 \text{.500} ; \qquad Inequality ( 4 )$$

$$0.56 0 ≦ Wcb / ( Tplup + Wc ) ≦ 2 \text{.250} ; \qquad Inequality ( 5 )$$

$$0.1 0 ≦ Wc / ( Ra max - Rc max ≦ 5. ; \qquad Inequality ( 6 )$$

$$7.2 ≦ Wa / Wc ≦ 28. ; \qquad Inequality ( 7 )$$

$$2.1 ≦ Wa / Wgs ≦ 5. ; \qquad Inequality ( 8 )$$

$$2.2 ≦ Wa / Wcb ≦ 6.7 ; \qquad Inequality ( 9 )$$

$$1.17 ≦ Ra max / Ro min ≦ 5. ; and / or \qquad Inequality ( 10 )$$

$$1.5 ≦ Ra max / CT max ≦ 4.350 , \qquad Inequality ( 11 )$$

in which each parameter is defined as described in the table in this disclosure, with reference to the length/width/thickness as marked in FIGS. 2 and 7.

When Inequality (1) is satisfied, the ratio of the width of the circular barrel mounting surface 113 to the width of the protruding rim 115 can be adjusted to avoid that the ratio is too large to decrease the effect of reducing demolding resistance, and to avoid that the ratio is too small to make the barrel mounting surface 113 too small to affect assembling of the plastic optical lens 100, and as a result, the molding and assembly yield are improved.

When Inequality (2) is satisfied, the ratio of the maximum width of the circular barrel mounting surface 113 to the maximum distance between an end of the conic surface 117, defined by the ring surface 115, and the first surface 111 can be adjusted to avoid that the ratio is too large to form an undesired rough edge affect assembling precision, and to avoid that the ratio is too small to make the barrel mounting surface 113 too small to affect assembling of the plastic optical lens 100, and as a result, the assembly yield is improved.

When Inequality (3) is satisfied, the ratio of the sum of the width of the circular barrel mounting surface 113 and the width of the protruding rim 115 to the maximum width of the ring surface 116 in the radial direction can be adjusted, so as to be advantageous to design the protruding rim 115 for the area of concentrated stress to reduce demolding resistance. The range is designed to avoid too large a ratio causing too much demolding resistance, and also to avoid too small a ratio causing the protruding rim 115 to affect assembling of the plastic optical lens 100.

When Inequality (4) is satisfied, the ratio of the width of the protruding rim 115 on the direction of the central axis I to the width of the protruding rim 115 on the radial side with the central axis I as the center can be adjusted to facilitate the design of the appropriate size of the protruding rim 115, avoiding the ratio from being too large to affect the assembly of the plastic optical lens 100, and also avoiding the ratio from being too small to increase the demolding resistance, thereby improving the molding accuracy.

When Inequality (5) is satisfied, the protruding rim 115 can be configured according to the position of the end of the conic surface 117 in the area where the stress is concentrated by adjusting the ratio of the maximum distance between the end of the conic surface 117, defined by the circular barrel mounting surface 113 and the ring surface 115, and first surface 111 to the sum of the thickness of the protruding rim 115 to reduce the stress concentration in that area. Inequality (5) is beneficial to avoiding that the ratio is too large to generate additional rough edges that affect the assembly precision, and at the same time, avoiding that the ratio is too small to cause the barrel mounting surface 113 is too small to affect the assembling of the plastic optical lens 100, thus improving the assembly yield.

When Inequality (6) is satisfied, the ratio of the width of the protruding rim 115 to the difference between the mounting portion 110 and the circular barrel mounting surface 113 can be adjusted to properly design the protruding rim 115 for the different sizes of the lens to reduce the demolding resistance, avoiding that the ratio is too large to affect the assembling of the plastic optical lens 100, and also avoiding that the ratio is too small to cause the demolding resistance, so as to improve the molding precision.

When Inequality (7) is satisfied, the ratio of the width of the protruding rim 115 to the width of the mounting portion 110 can be adjusted to avoid that the ratio is too large to lose the effect of lowering the demolding resistance, and at the same time to avoid that the ratio is too small to affect the assembling of the protruding rim 115, so as to improve the molding precision and enhance the assembly yield.

When Inequality (8) is satisfied, the ratio of the thicknesses of the mounting portion 110 to the thicknesses of the multi-chamfering corner 118 can be adjusted, which is advantageous for properly designing the multi-chamfering corner 118 to reduce the demolding resistance for the area where the stress is concentrated, and avoiding too large a ratio that would cause too much demolding resistance, and also avoiding too small a ratio that would cause the multi-chamfering corner 118 to affect the assembling of the plastic optical lens 100.

When Inequality (9) is satisfied, by adjusting the ratio of the thickness of the mounting portion 110 to the thickness of the circular barrel mounting surface 113, it is advantageous to retain the appropriate circular barrel mounting surface 113 for different thicknesses of the plastic optical lens 100, to avoid the ratio from being too large to affect the lens assembly, and at the same time, to avoid the ratio being too small to lose the effect of reducing the demolding resistance, thereby enhancing the assembly and molding yields.

When condition (10) is satisfied, the ratio of the maximum radius of the mounting portion 110 to the minimum radius of the optical portion 120 can be adjusted to facilitate the proper design of the mounting portion 110 for the different sizes of the plastic optical lens 100. By doing so, it is advantageous to avoid that the ratio is too large to affect the imaging quality, and at the same time, avoid that the ratio is too small to affect the precision of the assembly, and thus enhancing the assembly yield.

When Inequality (11) is satisfied, the plastic optical lens 100 can be designed properly for different products of the plastic optical lens 100 by adjusting the ratio of the maximum radius of the mounting portion 110 to the maximum thickness of the plastic optical lens 100.

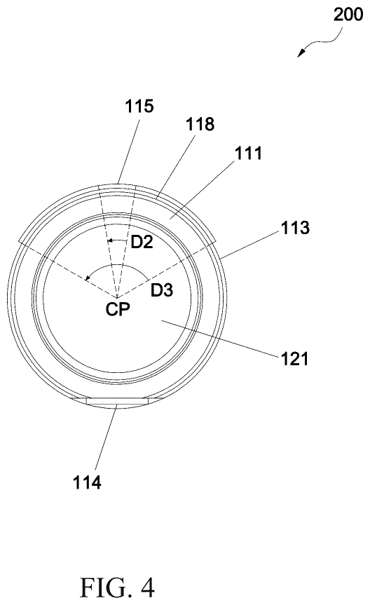

In the following, the plastic optical lens of each embodiment is described more clearly by emphasizing only the differences from the first embodiment, while the description of the similarities may be omitted. Referring to FIG. 4, a perspective view of a lens surface of a plastic optical lens according to a second embodiment of the present invention is shown. In the plastic optical lens 200 of the present embodiment, the extension range of the protruding rim 115 is modified to be within a third radial range D3 with the central axis I as the center. The third radial range D3 comprises the second radial range D2 in the direction opposite to the gate cutting surface 114, and here, the third radial range D3 is an arc length of a 120-degree central angle, with the central axis I as the center, for example.

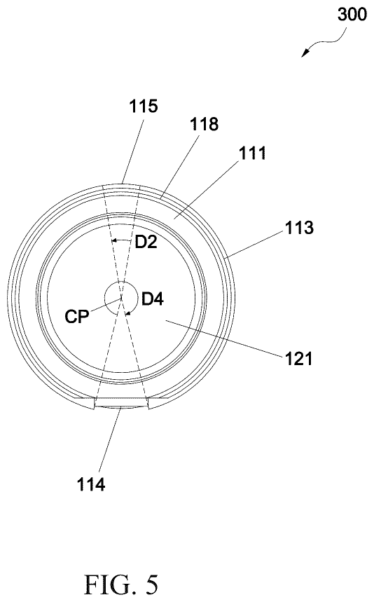

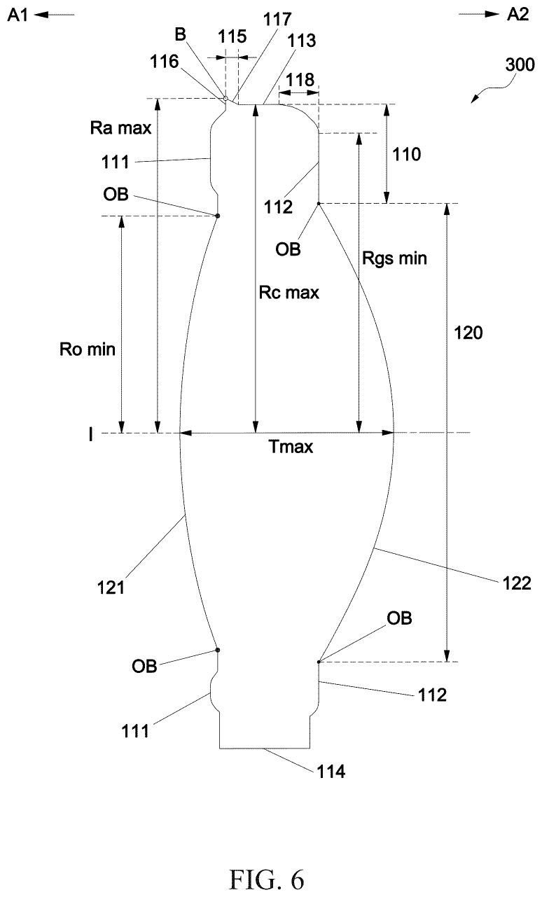

Referring to FIG. 5 and FIG. 6, FIG. 5 illustrates a perspective view of a lens surface of a plastic optical lens of a third embodiment of the present invention, and FIG. 6 illustrates a cross-sectional view of the plastic optical lens of the third embodiment of the present invention. In the plastic optical lens 300 of the present embodiment, the extension range of the protruding rim 115 is modified to be within a fourth radial range D4 with the central axis I as the center. The fourth radial range D4 comprises the second radial range D2 in the direction opposite to the gate cutting surface 114, and here, the fourth radial range D4 is an arc length of the outer surrounding the outer contour surface of the lens edge of the plastic optical lens 300, except for the gate cutting surface 114. In this design, the gate cutting surface 114 occupies an area equal to a 320-degree central angle with the central axis I as the center, and therefore the fourth radial range D4 is the arc length of the 320-degree central angle with the central axis I as the axis, but not limited thereto.

Referring to FIG. 7, a perspective diagram of a lens surface of a plastic optical lens of a fourth embodiment of the present invention is shown. In the plastic optical lens 400 of the present embodiment, the number of the multi-chamfering corners 118 and the sum of the central angles θgs are modified. Two multi-chamfering corners 118 are located immediately adjacent to each side of the gate cutting surface 114 respectively so that a distance W1 between them and the gate cutting surface 114 is nearly zero. The two multi-chamfering corners 118 together with the gate cutting surface 114 form a central angle D6 of about 60 degrees, with the central axis I as the center. In this design, the gate cutting surface 114 occupies a central angle of 40 degrees, so the sum of the two central angles θgs formed by the two multi-chamfering corners 118, with the central axis I as the center, is 20 degrees, but not limited thereto.

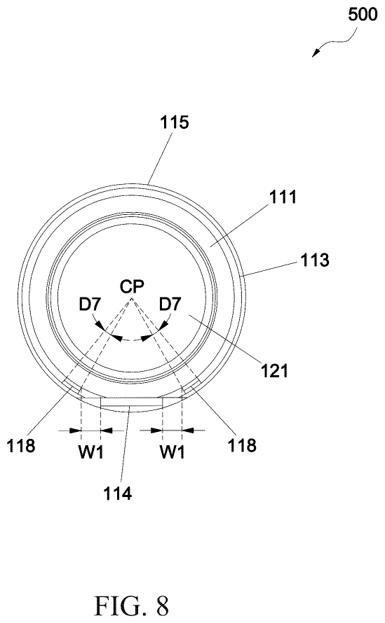

Referring to FIG. 8, a schematic diagram of a lens surface of a plastic optical lens of a fifth embodiment of the present invention is shown. In the plastic optical lens 500 of the present embodiment, the number of multi-chamfering corners 118 and the sum of the central angles θgs are modified. The two multi-chamfering corners 118 are located in vicinity of the gate cutting surface 114 with a distance W1 between them and the gate cutting surface 114. The distance W1 between each of the two multi-chamfering corners 118 and the gate cutting surface 114 is about 10 degrees. Therefore, the sum of the two centric angles θgs, formed by the two multi-chamfering corners 118, with the central axis I as the center, is identical to a centric angle of 20 degrees.

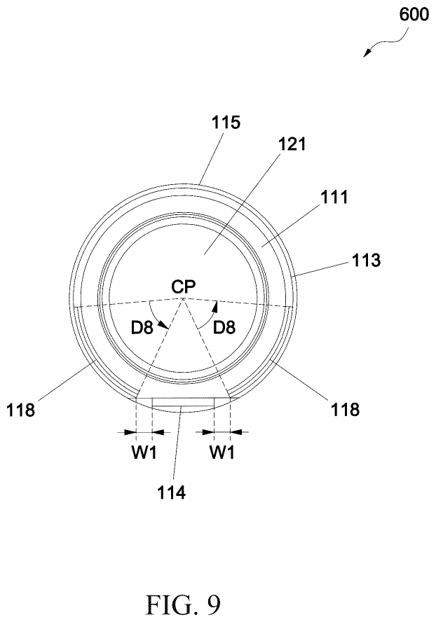

Referring to FIG. 9, a perspective view of a lens surface of a plastic optical lens of a sixth embodiment of the present invention is shown. In the plastic optical lens 600 of the present embodiment, the number of the multi-chamfering corners 118 and the sum of the centric angles θgs are varied. The two multi-chamfering corners 118 are located near the gate cutting surface 114 with a distance W1 therebetween. Each of the multi-chamfering corners 118 forms a centric angle D8 of about 60 degrees with the central axis I as the center. Therefore, the sum of the two centric angles θgs, formed by the two multi-chamfering corners 118, with the central axis I as the center, is identical to a centric angle of 120 degrees.

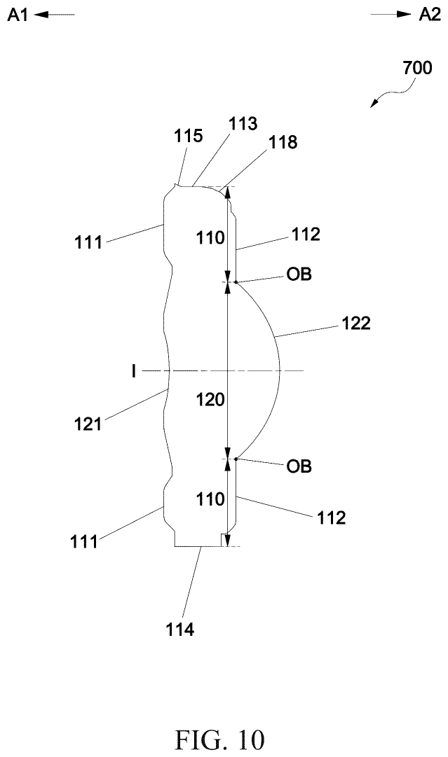

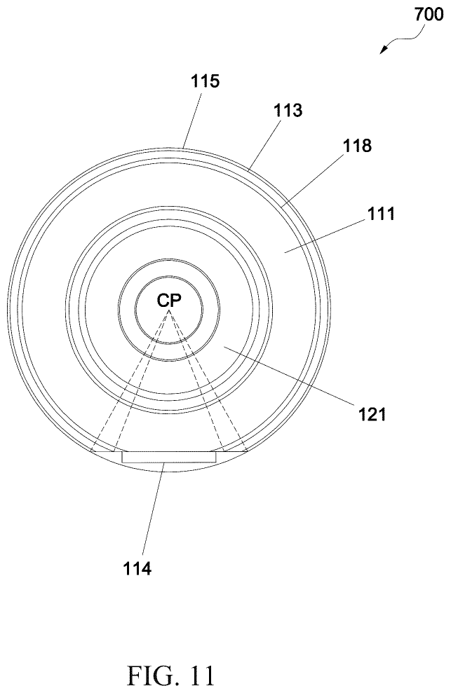

Referring to FIG. 10 and FIG. 11 together, FIG. 10 illustrates a cross-sectional view of a plastic optical lens of a seventh embodiment of the present invention, and FIG. 11 illustrates a perspective view of a lens surface of the plastic optical lens of the seventh embodiment of the present invention. The protruding rim 115 of the plastic optical lens 700 of the present embodiment extends over an arc length of a 302-degree centric angle, with the central axis I as the center, for example. The sum of the centric angle θgs formed by the multi-chamfering corner 118 and the central axis I is 306 degrees.

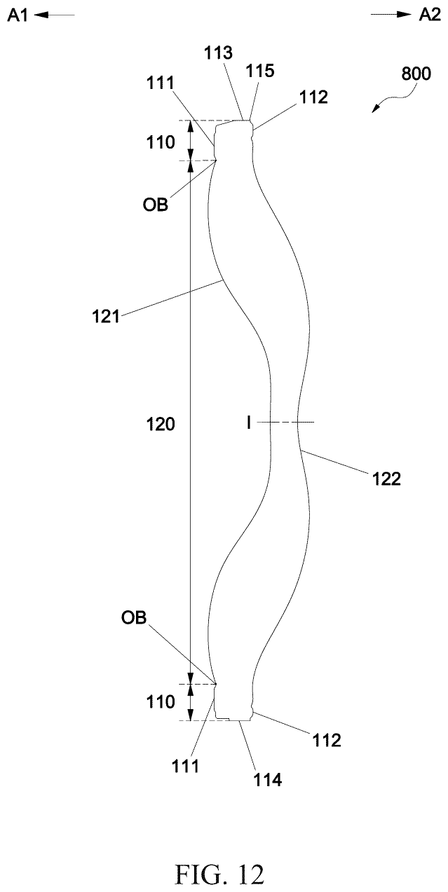

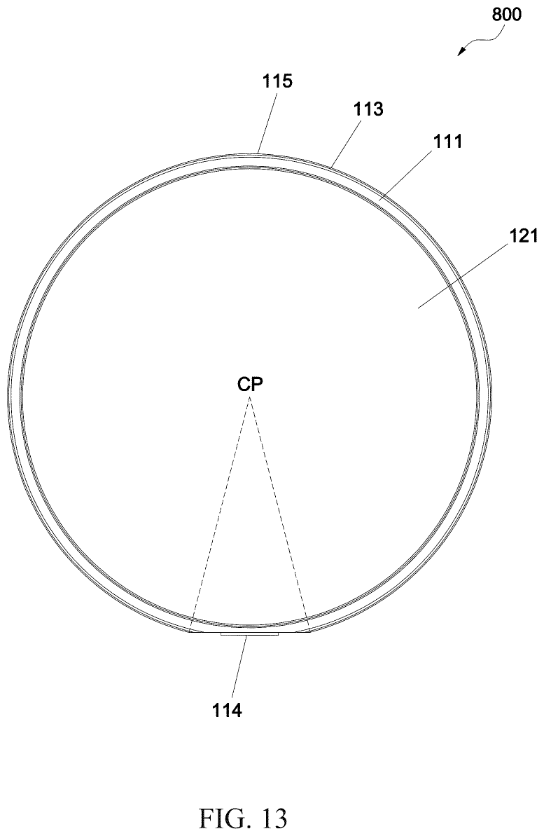

Referring to FIG. 12 and FIG. 13, in which FIG. 12 illustrates a cross-sectional view of a plastic optical lens of an eighth embodiment of the present invention, and FIG. 13 illustrates a perspective view of a lens surface of the plastic optical lens of the eighth embodiment of the present invention. The protruding rim 115 of the plastic optical lens 800 of the present embodiment extends over an arc length of a 331-degree central angle, with the central axis I as the center, for example, and no multi-chamfering corner is formed here.

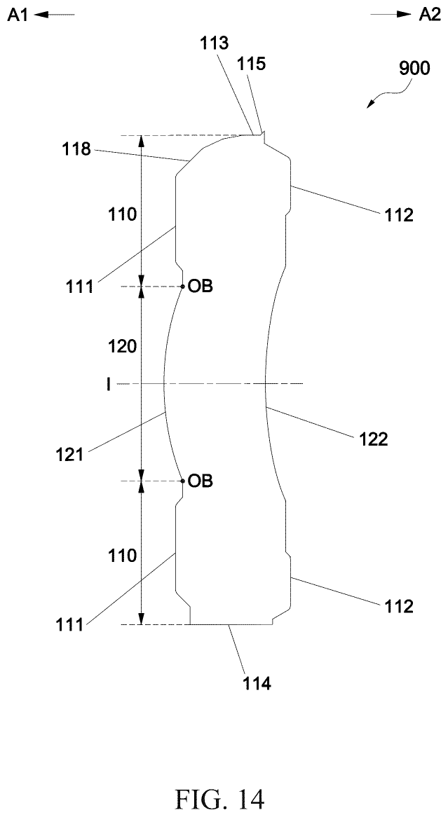

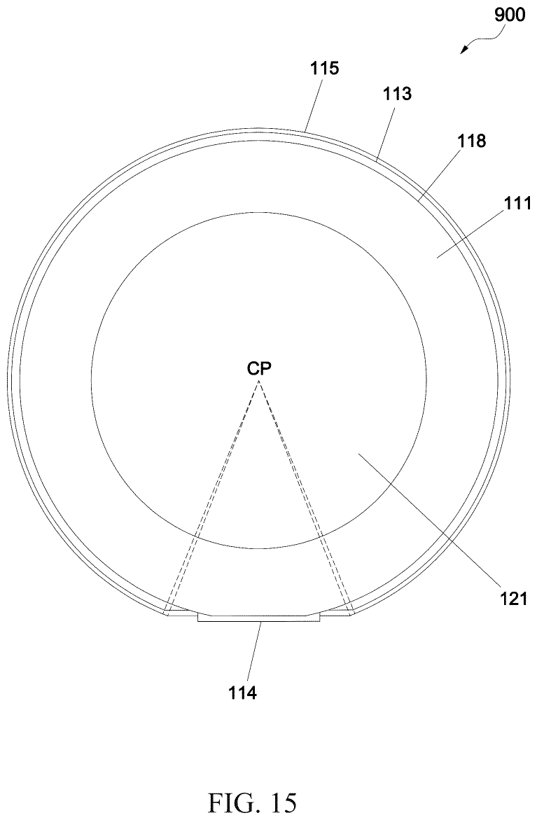

Referring to FIG. 14 and FIG. 15, wherein FIG. 14 depicts a cross-sectional view of a plastic optical lens of a ninth embodiment of the present invention, and FIG. 15 depicts a perspective view of a lens surface of the plastic optical lens of the ninth embodiment of the present invention. The extension range of the protruding rim 115 of the plastic optical lens 900 of the present embodiment is an arc length of a 317-degree central angle with the central axis I as the center. The sum of the central angles θgs formed by the multi-chamfering corner 118 and the central axis I is 315 degrees.

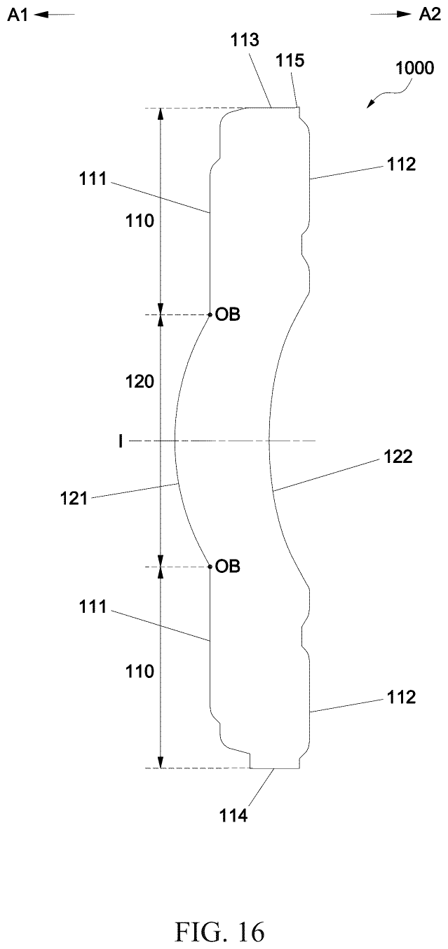

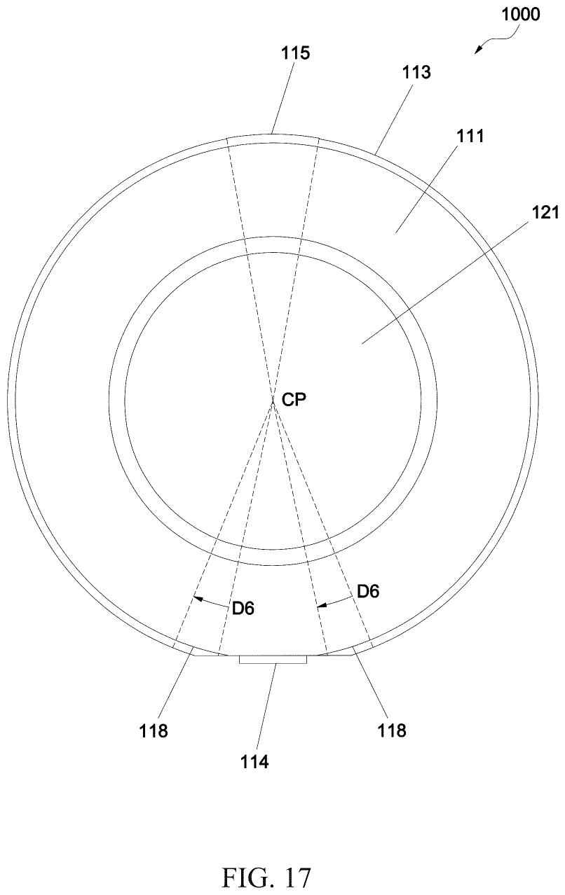

Referring to FIG. 16 and FIG. 17, in which FIG. 16 illustrates a cross-sectional view of a plastic optical lens of a tenth embodiment of the present invention, and FIG. 17 illustrates a schematic view of a lens surface of the plastic optical lens of the tenth embodiment of the present invention. The protruding rim 115 of the plastic optical lens 1000 of the present embodiment extends over an arc length of a 20-degree centric angle, with the central axis I as the center, in the direction opposite to the gate cutting surface 114 for example. Two multi-chamfering corners 118 are located near the gate cutting surface 114, and each multi-chamfering corner 118 forms a centric angle D6 of about 10 degrees, with the central axis I as the center. Therefore, the sum of the centric angles formed by the two multi-chamfering corners 118 with the central axis I as the center, Ogs, is identical to a centric angle of 20 degrees.

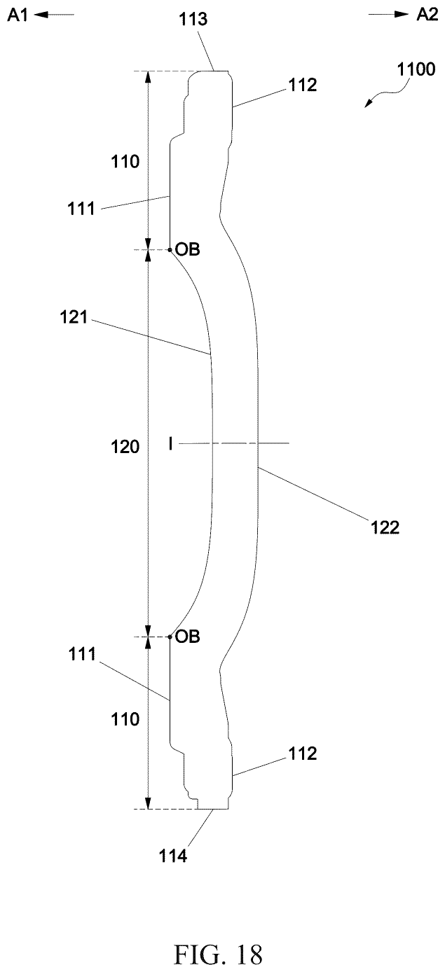

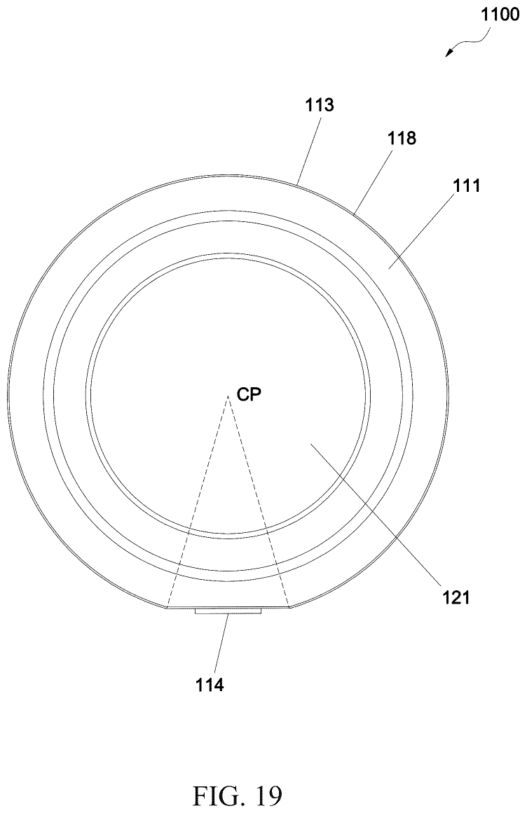

Referring to FIG. 18 and FIG. 19, wherein FIG. 18 illustrates a cross-sectional view of a plastic optical lens of an eleventh embodiment of the present invention, and FIG. 19 illustrates a perspective view of a lens surface of the plastic optical lens of the eleventh embodiment of the present invention. The multi-chamfering corner 115 of the plastic optical lens 1100 of the present embodiment comprises a centric angle D6 of about 330 degrees near the gate cutting surface 114, with the central axis I as the center, and no protruding rim is formed here.

In some other embodiments, the plastic optical lens may be designed to have either one of at least one multi-chamfering corner or the protruding rim to reduce resistance during demolding.

In addition, limitations of the plastic optical lens may be increased by selecting any combination of the parameters or value ranges of the embodiments to facilitate the design of the plastic optical lens with the same architecture of the present invention.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A plastic optical lens, comprising:
an optical portion, passed by a central axis; and
a mounting portion, enclosing at least a partial of the optical portion, the mounting portion comprising:
a first surface, facing a first side;
a circular barrel mounting surface;
a second surface, facing a second side and connecting with the circular barrel mounting surface;
a gate cutting surface, connecting with the circular barrel mounting surface; and
a protruding rim, formed within a first radial range, taking the central axis as the center, and connecting with the first surface and the circular barrel mounting surface, the first radial range comprising at least a second radial range opposite to the gate cutting surface, the protruding rim comprising a ring surface and a conic surface, the conic surface connecting with the ring surface and the circular barrel mounting surface, and the ring surface connecting with the first surface forming a maximum radius of lens the conic surface at the place where the conic surface connects with the ring surface, and
wherein the plastic optical lens satisfies 2.600≤Wcb/Wc≤11.700, in which Wc is a maximum width of the protruding rim in the mounting portion of the plastic optical lens, parallel to the central axis, Wcb is a maximum width of the circular barrel mounting surface in the mounting portion of the plastic optical lens, parallel to the central axis, and the plastic optical lens further satisfies 0.055≤θc/360 degrees≤0.920, in which θc represents a sum of at least one central angle formed by the first radial range and the central axis.

2. The plastic optical lens according to claim 1, further satisfying 1.300≤(Wc+Wcb)/Wcp≤11.000, in which Wcp is a maximum width of the circular barrel mounting surface in the mounting portion of the plastic optical lens along a radial direction, taking the central axis as the center.

3. The plastic optical lens according to claim 1, further satisfying 0.250≤Wc/Wcp≤2.500, in which Wcp is a maximum width of the circular barrel mounting surface in the mounting portion of the plastic optical lens along a radial direction, taking the central axis as the center.

4. The plastic optical lens according to claim 1, wherein the second surface comprises at least one multi-chamfering corner in vicinity of the gate cutting surface, the least one multi-chamfering corner connects with the circular barrel mounting surface, the least one multi-chamfering corner comprises at least a first surface and a second surface, the first surface, compared with the second surface, is relatively closer to the circular barrel mounting surface, two included angles formed by a tangent line of either the first surface or the second surface and the central axis are within 10~50 degrees, and among the two included angles, the one which is formed by the tangent line of the first surface and the central axis is smaller.

5. The plastic optical lens according to claim 1, further satisfying 2.200≤Wa/Wcb≤6.700, in which Wa is a maximum thickness of the mounting portion of the plastic optical lens, parallel to the central axis.

6. A plastic optical lens, comprising:
an optical portion, passed by a central axis; and
a mounting portion, enclosing at least a partial of the optical portion, the mounting portion comprising:
a first surface, facing a first side;
a circular barrel mounting surface;
a second surface, facing a second side and connecting with the circular barrel mounting surface;
a gate cutting surface, connecting with the circular barrel mounting surface; and
a protruding rim, formed within a first radial range, taking the central axis as the center, and connecting with the first surface and the circular barrel mounting surface, the first radial range comprising at least a second radial range opposite to the gate cutting surface, the protruding rim comprising a ring surface and a conic surface, the conic surface connecting with the ring surface and the circular barrel mounting surface, and the ring surface connecting with the first surface forming a maximum radius of lens the conic surface at the place where the conic surface connects with the ring surface, and
wherein the plastic optical lens satisfies 0.650≤Wcb/Tplup≤6.400, in which Wcb is a maximum width of the circular barrel mounting surface in the mounting portion of the plastic optical lens, parallel to the central axis, Tplup is a maximum distance between the circular barrel mounting surface of the plastic optical lens to the first surface of the plastic optical lens, and the plastic optical lens further satisfies 0.055≤θc/360 degrees≤0.920, in which θc represents a sum of at least one central angle formed by the first radial range and the central axis.

7. The plastic optical lens according to claim 6, further satisfying 0.560≤Wcb/(Tplup+Wc)≤2.250, in which Wc is a maximum width of the protruding rim in the mounting portion of the plastic optical lens, parallel to the central axis.

8. The plastic optical lens according to claim 6, further satisfying 0.100≤Wc/(Ra max−Rc max)≤5.000, in which Wc is a maximum width of the protruding rim in the mounting portion of the plastic optical lens, parallel to the central axis, Ra max is a maximum radius of the mounting portion of the plastic optical lens, and Rc max is a maximum radius of the circular barrel mounting surface of the plastic optical lens.

9. The plastic optical lens according to claim 6, further satisfying 7.200≤Wa/Wc≤28.000, in which Wa is a maximum thickness of the mounting portion of the plastic optical lens, parallel to the central axis, Wc is a maximum width of the protruding rim in the mounting portion of the plastic optical lens, parallel to the central axis.

10. The plastic optical lens according to claim 6, wherein the second surface comprises at least one multi-chamfering corner in vicinity of the gate cutting surface, the least one multi-chamfering corner connects with the circular barrel mounting surface, the least one multi-chamfering corner comprises at least a first surface and a second surface, the first surface, compared with the second surface, is relatively closer to the circular barrel mounting surface, two included angles formed by a tangent line of either the first surface or the second surface and the central axis are within 10~50 degrees, and among the two included angles, the one which is formed by the tangent line of the first surface and the central axis is smaller.

11. The plastic optical lens according to claim 10, wherein another central angle, formed by the at least one multi-chamfering corner and the central axis, satisfies 0.055≤θgs/360 degrees≤0.920, in which θgs is a sum of the central angle formed by the at least one multi-chamfering corner and the central axis.

12. A plastic optical lens, comprising:
an optical portion, passed by a central axis; and
a mounting portion, enclosing at least a partial of the optical portion, the mounting portion comprising:
a first surface, facing a first side;
a circular barrel mounting surface, connecting with the first surface and being parallel to the central axis;
a gate cutting surface, connecting with the circular barrel mounting surface; and
a second surface, facing a second side and connecting with the circular barrel mounting surface, the second surface comprising at least one multi-chamfering corner in vicinity of the gate cutting surface, the at least one multi-chamfering corner connecting with the circular barrel mounting surface, the at least one multi-chamfering corner comprising a first surface and a second surface, the first surface, compared with the second surface, being relatively closer to the circular barrel mounting surface, two included angles formed by a tangent line of either the first surface or the second surface and the central axis are within 10~45 degrees, and among the two included angles, the one, formed by the tangent line of the first surface and the central axis, being greater,
wherein the plastic optical lens satisfies 0.055≤θgs/360 degrees≤0.920 and 0.300≤Wcb/Wgs≤2.250, in which θgs represents a sum of at least one central angle formed by the at least one multi-chamfering corner and the central axis respectively, Web is a maximum width of the circular barrel mounting surface in the mounting portion of the plastic optical lens, parallel to the central axis, Wgs is a maximum width of the multi-chamfering corner in the mounting portion of the plastic optical lens, parallel to the central axis.

13. The plastic optical lens according to claim 12, further satisfying 2.100≤Wa/Wgs≤5.000, in which Wa is a maximum thickness of the mounting portion of the plastic optical lens, parallel to the central axis.

14. The plastic optical lens according to claim 12, further satisfying 1.170≤Ra max/Ro min≤5.000, in which Ra max is a maximum radius of the mounting portion of the plastic optical lens, and Ro min is a minimum radius of the optical portion of the plastic optical lens.

15. The plastic optical lens according to claim 12, further satisfying 1.500≤Ra max/CTmax≤4.350, in which Ra max is a maximum radius of the mounting portion of the plastic optical lens, and CTmax is a maximum thickness of the plastic optical lens along the central axis.
